(19) United States
(12) Patent Application Publication
(10) Pub. No.: US 2013/0209755 A1
(43) Pub. Date: Aug. 15, 2013

(54) SELF-ASSEMBLED STRUCTURES, METHOD OF MANUFACTURE THEREOF AND ARTICLES COMPRISING THE SAME

(71) Applicants: Phillip Dene Hustad, Manvel, TX (US); Peter Trefonas, III, Medway, MA (US); Shih-Wei Chang, Natick, MA (US); Erin Beth Vogel, Midland, MI (US)

(72) Inventors: Phillip Dene Hustad, Manvel, TX (US); Peter Trefonas, III, Medway, MA (US); Shih-Wei Chang, Natick, MA (US); Erin Beth Vogel, Midland, MI (US)

(21) Appl. No.: 13/397,470

(22) Filed: Feb. 15, 2012

(51) Int. Cl. B32B 3/00; B44C 1/22; C08F 220/22

(52) U.S. Cl. 428/195.1; 526/244; 216/49

(57) ABSTRACT

Disclosed herein is a method of manufacturing self assembled structures that have lamellae or cylinders whose longitudinal axis is parallel or perpendicular to a surface upon which the self assembled structure is disposed. The method comprises disposing a random copolymer on the substrate to form a surface modification layer and disposing a block copolymer on the surface modification layer. The block copolymer is then subjected to etching.

### BACKGROUND

This disclosure relates to self assembled structures, methods of manufacture thereof and to articles comprising the same. In particular, the present disclosure relates to self assembled nanostructures obtained by disposing a block copolymer over a polymeric layer that exists in the form of a brush or a mat.

Block copolymers form self-assembled nanostructures in order to reduce the free energy of the system. Nanostructures are those having average largest widths or thicknesses of less than 100 nanometers. This self-assembly produces periodic structures as a result of the reduction in free energy. The periodic structures can be in the form of domains, lamellae or cylinders. Because of these structures, thin films of block copolymers provide spatial chemical contrast at the nanometer-scale and, therefore, they have been used as an alternative low-cost nano-patterning material for generating periodic nanoscale structures. While these block copolymer films can provide contrast at the nanometer scale, it is however often very difficult to produce copolymer films that can display periodicity at less than 20 nanometers. Modern electronic devices however often utilize structures that have a periodicity of less than 20 nanometers and it is therefore desirable to produce copolymers that can easily display structures that have average largest widths or thicknesses of less than 20 nanometers, while at the same time displaying a periodicity of less than 20 nanometers.

Many attempts have been made to develop copolymers that have average largest widths or thicknesses of less than 20 nanometers, while at the same time displaying a periodicity of less than 20 nanometers. The following discussion details some of the attempts that have been made to accomplish this.

FIGS. 1A and 1B depict examples of lamella forming block copolymers that are disposed upon a substrate. The block copolymer comprises a block A and a block B that are reactively bonded to each other and that are immiscible with each other. The lamellae can align their domains to be either parallel (FIG. 1A) or perpendicular (FIG. 1B) to the surface of a substrate surface upon which they are disposed. The perpendicularly oriented lamellae provide nanoscale line patterns, while there is no surface pattern created by parallel oriented lamellae. Where lamellae form parallel to the plane of the substrate, one lamellar phase forms a first layer at the surface of the substrate (in the x-y plane of the substrate), and another lamellar phase forms an overlying parallel layer on the first layer, so that no lateral patterns of microdomains and no lateral chemical contrast form when viewing the film along the perpendicular (z) axis. When lamellae form perpendicular to the surface, the perpendicularly oriented lamellae provide nanoscale line patterns. Therefore, to form a useful pattern, control of the orientation of the self-assembled microdomains in the block copolymer is desirable.

Without external orientation control, thin films of block copolymers tend to self-organize into randomly oriented nanostructures with undesired morphologies, which are of little use for nano-patterning because of the random nature of the features. Orientation of block copolymer microdomains can be obtained by guiding the self-assembly process with an external orientation biasing method. Examples of this biasing method include the use of a mechanical flow field, an electric field, a temperature gradient, or by using a surface modification layer upon which the block copolymer is disposed. The copolymers generally used for these particular form of guided self-assembly are polystyrene-polymethylmethacrylate block copolymers or polystyrene-poly(2-vinylpyridine) block copolymers.

The FIG. 2 details one method of using a surface modification layer upon which a block copolymer is disposed to produce a film having controlled domain sizes and periodicity. The method depicted in the FIG. 2, has been previously detailed by Kim, S. O.; Solak, H. H.; Stoykovich, M. P.; Ferrier, N. J.; de Pablo, J. J.; Nealey, P. F. Nature 2003, 424, 411-414 and by Edwards, E. W.; Montague, M. F.; Solak, H. H.; Hawker, C. J.; Nealey, P. F. Adv. Mater. 2004, 16, 1315-1319. As with the FIG. 1, the block copolymer of the FIG. 2 comprises a block A and a block B. The substrate in the FIG. 2 is coated with a surface modification layer that is affixed to the surface. The surface modification layer is formed by crosslinking or is reactively bonded (covalently, ionically or hydrogen bonded) to the surface of the substrate. Any additional excess material is removed prior to or during the bonding. The block copolymer is then coated on the surface modification layer of the substrate.

The block copolymer is annealed with heat (in the presence of an optional solvent), which allows for phase separation of the immiscible polymer blocks A and B. The annealed film can then be further developed by a suitable method such as immersion in a solvent/developer or by reactive ion etching which preferentially dissolves one polymer block and not the other to reveal a pattern that is commensurate with the positioning of one of the blocks in the copolymer. While this method generates self assembled films with a uniform spacing, it has not proved useful in continuously and uniformly generating self assembled films having domain sizes of less than 20 nanometers with a periodicity of less than 20 nanometers.

### SUMMARY

Disclosed herein is a polymer composition, comprising a random copolymer derived by reacting a monomer represented by formula (1):

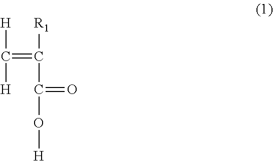

where R₁ is a hydrogen or an alkyl group having 1 to 10 carbon atoms; or a monomer having a structure represented by the formula (2):

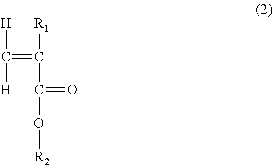

where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group; with a monomer that has at least one fluorine atom substituent and that has a structure represented by the formula (3):

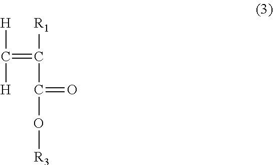

where R₁ is a hydrogen or an alkyl group having 1 to 10 carbon atoms and R₃ is a C₂₋₁₀ fluoroalkyl group.

Disclosed herein too is a method of forming a pattern, comprising disposing a block copolymer comprising a siloxane-containing block and a non-siloxane containing block, on a surface of a substrate having a random copolymer disposed thereon; the random copolymer having a total surface energy of 15 to 40 milliNewtons per met and comprising at least one substitutent that comprises a fluorine atom; annealing the block copolymer to phase separate regions containing the siloxane containing block from those containing the non-siloxane containing block, and etching the block copolymer to selectively remove either the region containing the siloxane-containing block, or the non-siloxane containing block.

Disclosed herein too is a patterned substrate, comprising a substrate having a random copolymer disposed thereon; the random copolymer derived by reacting a monomer represented by formula (1):

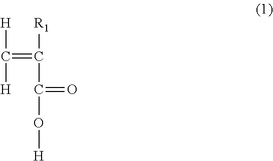

where R₁ is a hydrogen or an alkyl group having 1 to 10 carbon atoms; or a monomer having a structure represented by the formula (2):

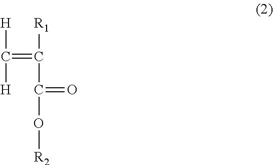

where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group; with a monomer that has at least one fluorine atom substituent and that has a structure represented by the formula (3):

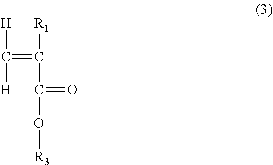

where R₁ is a hydrogen or an alkyl group having 1 to 10 carbon atoms and R₃ is a C₂₋₁₀ fluoroalkyl group; where the random copolymer comprises an attachment group or a chain terminating group that comprises a hydroxyl group, carboxylic acid group, epoxy group, silane group, or a combination comprising at least one of the foregoing groups; and a pattern layer disposed on the random copolymer, the pattern layer comprising a block copolymer comprising a siloxane-containing block and a non-siloxane containing block phase separated into regions containing the siloxane containing block and the non-siloxane containing block, wherein the phase separated regions are lamellar having a longitudinal axis oriented parallel to the surface, or cylindrical having a longitudinal axis oriented perpendicular to the surface, or both.

### BRIEF DESCRIPTION OF THE DRAWINGS

FIGS. 1A and 1B depict examples of lamella forming block copolymers that are disposed upon a substrate;

FIG. 2 details one method of using a surface modification layer upon which a block copolymer is disposed to produce a film having controlled domain sizes and periodicity;

FIG. 3 depicts a method of using the disclosed surface modification layer to obtain a block copolymer that has domains that are in a perpendicular orientation to the substrate;

FIGS. 4A-4E depicts a method that uses a first surface modification layer and a second surface modification layer designed to “pin” or selectively interact with the first or second block of the block copolymer to produce domains that are in a perpendicular orientation to the substrate;

FIG. 5A is a photomicrograph showing the orientation of the film after annealing at 200° C. for 1 hour;

FIG. 5B is a photomicrograph showing the perpendicular orientation of the film after annealing at 290° C. for 1 hour;

FIG. 6 is a photomicrograph showing the block copolymer morphology disposed on the random copolymer after annealing at 290° C. for 1 hour;

FIG. 7 is a photomicrograph showing the thin film morphology on the random copolymer surface modification layer after annealing at 290° C. for 1 hour which reveals a mixture of parallel and perpendicular cylinders;

FIG. 8 is a photomicrograph depicting perpendicular cylinders along with some de-wetting in a PS-PDMS block copolymer film;

FIG. 9 is a micrograph showing the thin film morphology of the block copolymer on the surface modification layer after annealing at 340° C. for 1 hour.

FIG. 10 is a micrograph showing the thin film morphology on the surface modification layer, which reveals a mixture of parallel and perpendicular cylinders;

FIG. 11 is a micrograph of the block copolymer thin film disposed on the surface modification layer and shows only perpendicular cylinders;

FIG. 12 is a micrograph showing the thin film block copolymer morphology that is consistent with parallel orientation of lamella and with no sign of fine structure that is indicative of perpendicular orientation;

FIG. 13 is a micrograph of a 42 nm thick film annealed at 290° C. for 1 hour;

FIG. 14A is a micrograph of a 42 nm thick block copolymer film annealed at 340° C. for 1 hour; and

FIG. 14B is a micrograph revealing the morphology of the block copolymer after it is cleaved. This morphology reveals oxidized PDMS lines with a height of ˜25 nm.

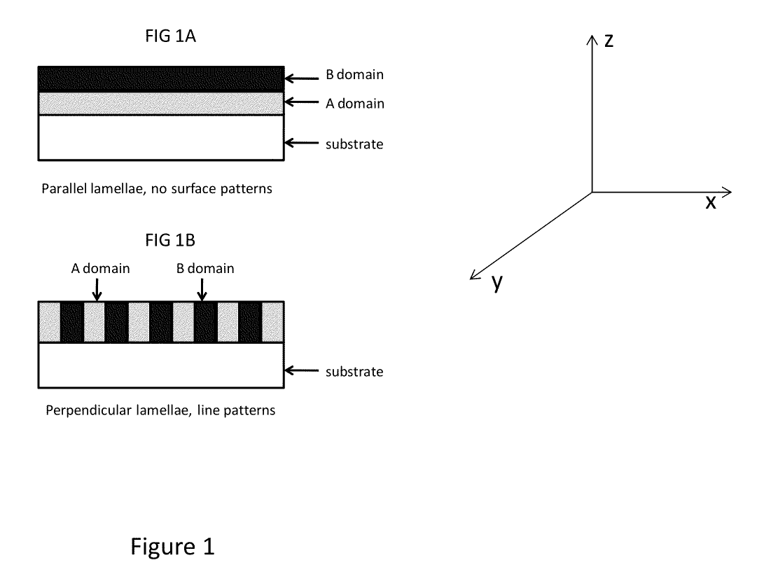

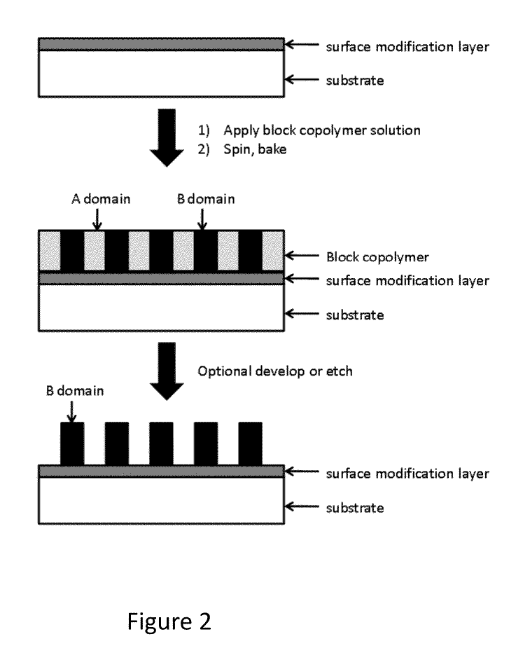

### DETAILED DESCRIPTION

As used herein, “phase-separate” refers to the propensity of the blocks of the block copolymers to form discrete microphase-separated domains, also referred to as “microdomains” or “nanodomains” and also simply as “domains”. The blocks of the same monomer aggregate to form periodic domains, and the spacing and morphology of domains depends on the interaction and volume fraction among different blocks in the block copolymer. Domains of block copolymers can form during applying, such as during a spin-casting step, during a heating step, or can be tuned by an annealing step. “Heating”, also referred to herein as “baking”, is a general process wherein the temperature of the substrate and coated layers thereon is raised above ambient temperature. “Annealing” can include thermal annealing, thermal gradient annealing, solvent vapor annealing, or other annealing methods. Thermal annealing, sometimes referred to as “thermal curing” can be a specific baking process for fixing patterns and removing defects in the layer of the block copolymer assembly, and generally involves heating at elevated temperature (e.g., 150° C. to 350° C.), for a prolonged period of time (e.g., several minutes to several days) at or near the end of the film-forming process. Annealing, when performed, is used to reduce or remove defects in the layer (referred to as a “film” hereinafter) of microphase-separated domains.

The self-assembling layer comprising a block copolymer having at least a first block and a second block that forms domains through phase separation that orient perpendicular to the substrate upon annealing. “Domain”, as used herein, means a compact crystalline, semi-crystalline, or amorphous region formed by corresponding blocks of the block copolymer, where these regions may be lamellar or cylindrical and are formed orthogonal or perpendicular to the plane of the surface of the substrate and/or to the plane of a surface modification layer disposed on the substrate. In an embodiment, the domains may have an average largest dimension of 1 to 100 nanometers (nm), specifically 5 to 75 nm, and still more specifically 5 to 30 nm.

The term “PS-b-PDMS block copolymer” used herein and in the appended claims is short hand for a poly(styrene)-block-poly(dimethylsiloxane) diblock copolymer.

The term “Mₙ” used herein and in the appended claims in reference to a block copolymer of the present invention is the number average molecular weight of the block copolymer (in g/mol) determined according to the method used herein in the Examples.

The term “M_{W}” used herein and in the appended claims in reference to a block copolymer of the present invention is the weight average molecular weight of the block copolymer (in g/mol) determined according to the method used herein in the Examples.

The term “PD” used herein and in the appended claims in reference to a block copolymer of the present invention is the polydispersity of the block copolymer determined according to the following equation:

$$PD = \frac{{M}_{W}}{{M}_{n}} .$$

The term “average molecular weight” used herein and in the appended claims in reference to (a) a PS-b-PDMS block copolymer component that is a single PS-b-PDMS block copolymer, means the number average molecular weight for that PS-b-PDMS block copolymer; and (b) a PS-b-PDMS block copolymer component that is a blend of two or more different PS-b-PDMS block copolymers, means the weighted average of the number average molecular weights, Mₙ, of the two or more different PS-b-PDMS block copolymers in the blend.

The term “Wf_{PS}” used herein and in the appended claims in reference to a PS-b-PDMS block copolymer is the weight percent of the poly(styrene) block in the block copolymer.

The term “Wf_{PDMs}” used herein and in the appended claims in reference to a PS-b-PDMS block copolymer of the present invention is the weight percent of the poly(dimethylsiloxane) block in the block copolymer.

Disclosed herein is a composition for a surface modification layer and a composition for a block copolymer that when disposed upon the surface modification layer produces domains having largest average sizes of less than or equal to 20 nanometers and an interdomain periodicity of less than or equal to 20 nanometers. The domains are generally either lamellar or cylindrical. In one embodiment, the domains are lamellar having a longitudinal axis oriented parallel to the surface (i.e., the longitudinal axis of a lamellae is perpendicular to a perpendicular drawn to the surface of the substrate), or cylindrical having a longitudinal axis oriented perpendicular to the surface (i.e., the longitudinal axis of a cylinder is parallel to a perpendicular drawn to the surface of the substrate), or both. This orientation of the lamellar or cylindrical domains will hereinafter be referred to as being in a perpendicular orientation to the surface of the substrate. The longitudinal axis is one that is substantially parallel to the largest dimension of one of the domains of the block copolymer. In one embodiment, the longitudinal axis of at least two chemically dissimilar domains are substantially parallel to largest dimension of both of the domains of the block copolymer and are also substantially parallel to each other.

Disclosed herein too is a method of manufacturing a block copolymer film that has domains in a perpendicular orientation to the surface of the substrate, where the domains size is less than or equal to 100 nanometers and the interdomain periodicity is less than or equal to 100 nanometers. The method comprises matching surface energies of the surface modification layer and the bulk copolymer that is disposed upon the surface modification layer so as to produce a film that have domains in a perpendicular orientation. The method advantageously does not involve the use of non-equilibrium processes such as solvent annealing.

Furthermore, this disclosure relates to a structure comprising a substrate; a (perpendicular orientation inducing) surface modification layer comprising a random copolymer disposed on the substrate; and a self-assembled patterned diblock copolymer film disposed on the surface modification layer, wherein the random copolymer induces a stable perpendicular orientation in the diblock copolymer film.

In addition, the present disclosure relates to a method for providing a structure which comprises disposing over a substrate the surface modification layer with controlled surface energy; forming a film of a diblock copolymer on the surface modification layer; wherein the surface modification layer induces a stable perpendicular orientation in the diblock copolymer film; and further processing to thereby create a combined self-assembled pattern in the diblock copolymer film.

In addition, the present disclosure relates to a method for providing a structure which comprises providing a substrate decorated with a pattern of guiding lines of a brush or mat polymer (or equivalent) with width similar or identical to that of the first domain; filling the unpatterned regions of the patterned substrate with the (perpendicular orientation inducing) surface modification layer with controlled surface energy; forming a film of the diblock copolymer on the chemically patterned substrate of guiding stripes and the perpendicular orientation inducing surface modification layer; wherein the patterned substrate induces a stable perpendicular orientation in the diblock copolymer film and directs the self-assembly to form a highly aligned block copolymer morphology; and further processing to thereby create a combined self-assembled pattern with long range order useful as a etch mask for the creation of semiconductor features. The brush layer comprises molecules of the random copolymer that are covalently bonded to the surface of the substrate, where the chain backbone of the random copolymer are substantially perpendicular to the surface of the substrate. The mat layer comprises molecules of the random copolymer that are covalently bonded to the surface of the substrate, where the chain backbone of the random copolymer are substantially parallel to the surface of the substrate.

The surface modification layer comprises a random copolymer comprising two or more homopolymeric repeat units that have difference in surface energy of 10 to 20 nano Newton per meter (mN/m). Each repeat unit is chemically and/or structurally different from the other repeat units in the random copolymer. The random copolymer comprises a first homopolymeric repeat unit having a surface energy of 35 to 50 mN/m and a second repeat unit having a surface energy of 15 to 30 mN/m. The total surface energy of the random copolymer is 15 to 40 mN/m. The surface energy is calculated using the Owens-Wendt method from the contact angles of water (18 ohm deionized water) and methylene iodide (CH₂I₂) and diethylene glycol, which are measured on a contact angle goniometer by the Sessile Drop method. In one embodiment, an exemplary first repeat unit is derived from an acrylate monomer, while the second repeat unit is derived from a monomer that comprises at least one fluorine substituent. In one embodiment, the surface modification layer comprises a random copolymer comprising at least three repeat units, where each repeat unit is chemically and/or structurally different from the other repeat units in the random copolymer.

In one embodiment, the surface modification layer comprises a random copolymer that can be crosslinked upon being disposed upon the substrate. The random copolymer comprises at least two repeat units at least one of which contains a reactive substituent along the chain backbone that can be used to crosslink the random copolymer after it is disposed upon the substrate. The surface modification layer crosslinked in this manner is then described as being in the form of a mat-like film on the surface of the substrate.

In another embodiment, the surface modification layer comprises a random copolymer that comprises a reactive endgroup that can react with a functional group disposed upon the surface of the substrate to form a brush on the substrate. The surface modification layer disposed upon the substrate in this manner is then described as being in the form of a brush on the surface of the substrate.

In yet another embodiment, the surface modification layer comprises a random copolymer that comprises at least one reactive substituent along the chain backbone and in addition comprises a reactive endgroup that can react with a functional group disposed upon the surface of the substrate to form a brush on the substrate. A copolymer containing both reactive functionalities can thus form either a mat or a brush depending upon the kinetics of the reaction. For example, if the endgoups are first reacted with the substrate followed by reacting the substituents, the surface modified film is expected to have characteristics that are more brush-like than mat-like. However, if the crosslinking reaction is first triggered, followed by reacting the surface groups, then the surface film will have characteristics that are more mat-like and less brush-like. Reaction conditions, the reactants, the solvents use to disperse the reactants, the chemistry of the substrate, and the structure and chemistry of the random copolymer can thus all be tailored to tune in the type of surface characteristics that are desired in the surface modification film and consequently in the block copolymer.

In one embodiment, the first repeat unit (i.e., the acrylate monomer) has a structure derived from a monomer represented by formula (1):

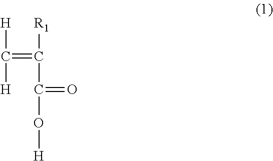

where R₁ is a hydrogen or an alkyl group having 1 to 10 carbon atoms. Examples of the first repeat monomer are acrylates and alkyl acrylates such as, for example, methyl acrylates, ethyl acrylates, propyl acrylates, or the like, or a combination comprising at least one of the foregoing acrylates.

In one embodiment, the first repeat unit has a structure derived from a monomer having a structure represented by the formula (2):

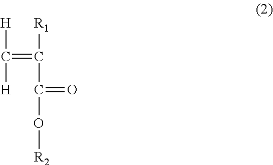

where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group. Examples of the (meth)acrylates are methacrylate, ethacrylate, propyl acrylate, methyl methacrylate, methyl ethylacrylate, methyl propylacrylate, ethyl ethylacrylate, methyl arylacrylate, or the like, or a combination comprising at least one of the foregoing acrylates. The term “(meth)acrylate” implies that either an acrylate or methacrylate is contemplated unless otherwise specified.

As noted above, the second repeat unit is derived from a monomer that has at least one fluorine atom substituent and has a structure represented by the formula (3):

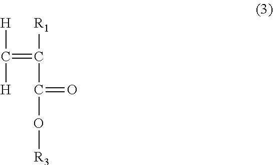

where R₁ is a hydrogen or an alkyl group having 1 to 10 carbon atoms and R₃ is a C₂₋₁₀ fluoroalkyl group. Examples of compounds having the structure of formula (3) are trifluoro ethyl methacrylate, and dodecafluoroheptylmethacrylate.

The random copolymer used for the surface modification layer comprises at least two of the foregoing structures (1), (2) and (3) as depicted in the formula shown in the structure (4):

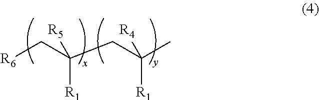

wherein x and y are mole fractions whose sum is equal to 1, where x is 0.001 to 0.999, specifically 0.05 to 0.95, where y is 0.001 to 0.999, specifically 0.05 to 0.95; where R₁ is a hydrogen or a C₁₋₁₀ alkyl group and may be the same or different in the different repeat units, R₄ is a carboxylic acid group, a C₁₋₁₀ alkyl ester group, a C₃₋₁₀ cycloalkyl ester group or a C₇₋₁₀ aralkyl ester group and R₅ is a C₂₋₁₀ fluoroalkyl ester group. R₆ represents an end group (also known as the chain terminating group) or an attachment group and is used to covalently bond the copolymer to the substrate. In one embodiment, R₆ is not always a reactive end group, but can be an end group that does not react with the substrate.

The end group of the random copolymer used in the surface modification layer can optionally be a group containing a reactive functional group capable of forming a covalent bond to a substrate or inducing crosslinking in the polymer film. The random copolymer can also have an attachment group that is not a chain terminating group, but which is a substituent on the backbone of the random copolymer. The end group R₆ may be a hydroxy, thiol, or primary or secondary amine substituted, straight chain or branched C₁₋₃₀ alkyl, C₃₋₃₀ cycloalkyl, C₆₋₃₀ aryl, C₇₋₃₀ alkaryl, C₇₋₃₀ aralkyl, C₁₋₃₀ heteroalkyl, C₃₋₃₀ heterocycloalkyl, C₆₋₃₀ heteroaryl, C₇₋₃₀ heteroalkaryl, C₇₋₃₀ heteroaralkyl or a combination comprising at least one of these groups. As used herein, the prefix “hetero” refers to any non-carbon, non-hydrogen atom including, for example, the halogens (fluorine, chlorine, bromine, iodine), boron, oxygen, nitrogen, silicon, or phosphorus, unless otherwise specified.

In on embodiment, the end groups include 3-aminopropyl, 2-hydroxyethyl, 2-hydroxypropyl, or 4-hydroxyphenyl. Alternatively, or in addition to these functional groups, other reactive functional groups may be included to facilitate bonding of the acid sensitive copolymer to the surface of a substrate.

In another embodiment, the end groups include mono-, di- and trialkoxysilane groups such as 3-propyltrimethoxysilane (obtained by the copolymerization of other monomers with trimethoxysilylpropyl(meth)acrylate), or glycidyl groups (obtained by the copolymerization with glycidyl(meth)acrylate). In addition, groups capable of crosslinking, such as benzocyclobutene, azide, acryloyl, glycidyl, or other crosslinkable groups may be used. Useful monomers which provide the epoxy-containing attachment group include monomers selected from the group consisting of glycidyl methacrylate, 2,3-epoxycyclohexyl(meth)acrylate, (2,3-epoxycyclohexyl)methyl(meth)acrylate, 5,6-epoxynorbornene(meth)acrylate, epoxydicyclopentadienyl(meth)acrylate, and combinations comprising at least one of the foregoing.

Exemplary end groups are hydroxyl groups, carboxylic acid groups, epoxy groups, silane groups, or a combination comprising at least one of the foregoing groups.

In an exemplary embodiment, the random copolymer of the surface modification layer can comprise two different repeat units and has the structure of formula (5):

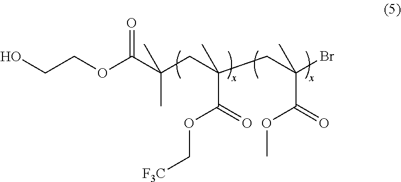

where the mole fraction x is 0.01 to 0.99, specifically 0.10 to 0.97, and more specifically 0.25 to 0.95, while mole fraction y is 0.99 to 0.01, specifically 0.90 to 0.03, and more specifically 0.75 to 0.05, and where the sum of mole fractions x and y is 1.

In another exemplary embodiment, the random copolymer of the surface modification layer can comprise two different repeat units and has the structure of formula (6):

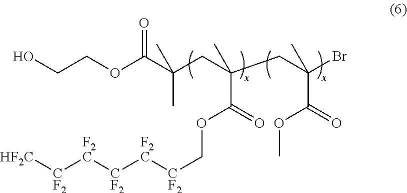

where the mole fraction x is 0.01 to 0.99, specifically 0.10 to 0.97, and more specifically 0.25 to 0.95, while mole fraction y is 0.99 to 0.01, specifically 0.90 to 0.03, and more specifically 0.75 to 0.05, and where the sum of mole fractions x and y is 1.

In one embodiment, the random copolymer comprises at least three different repeat units and has the structure of formula (7):

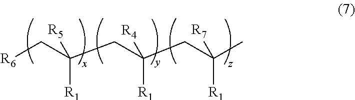

where x, y and z are mole fractions, the sum of which are equal to 1. In one embodiment, x is 0.001 to 0.999, specifically 0.05 to 0.95, where y is 0.001 to 0.999, specifically 0.05 to 0.95, and z is 0 to 0.9. In the formula (7), R₁ is a hydrogen or a C₁₋₁₀ alkyl group and may be the same or different in each of the repeat units, R₄ is a carboxylic acid group, a C₁₋₁₀ alkyl ester group, a C₃₋₁₀ cycloalkyl ester group or a C₇₋₁₀ aralkyl ester group and R₅ is a C₂₋₁₀ fluoroalkyl ester group and R₇ is either a C₂₋₁₀ fluoroalkyl ester group that is not the same as R₅ or is a C₁₋₁₀ alkyl ester group, a C₃₋₁₀ cycloalkyl ester group or a C₇₋₁₀ aralkyl ester group that is not the same as R₄. R₆ represents an end group (also known as the attachment group) and is used to covalently bond the copolymer to the substrate. R₆ is not always a reactive end group. Various examples for R₆ have been provided above.

In another embodiment, the random copolymer of the surface modification layer can comprise three different repeat units and has the structure of formula (8):

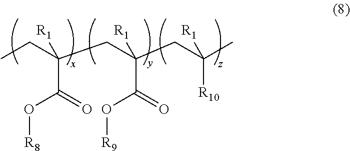

where x, y and z are mole fractions, the sum of which are equal to 1. In one embodiment, x is 0.001 to 0.999, specifically 0.05 to 0.95, where y is 0.001 to 0.999, specifically 0.05 to 0.95, and z is 0.001 to 0.9. In the formula (8), R₁ is a hydrogen or a C₁₋₁₀ alkyl group and may be the same or different in each of the repeat units, R₈ and R₉ are different from each other and are one of a carboxylic acid group, a C₁₋₁₀ alkyl ester group, a C₃₋₁₀ cycloalkyl ester group or a C₇₋₁₀ aralkyl ester group or a C₂₋₁₀ fluoroalkyl ester group and R₁₀ is a C₁₋₃₀ attachment group comprising a hydroxy group.

In another embodiment, the random copolymer of the surface modification layer can comprise three different repeat units and has the structure of formula (9):

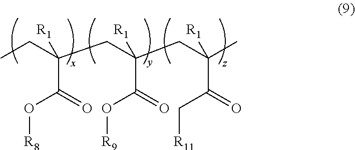

where x, y and z are mole fractions, the sum of which are equal to 1. In one embodiment, x is 0.001 to 0.999, specifically 0.05 to 0.95, where y is 0.001 to 0.999, specifically 0.05 to 0.95, and z is 0.001 to 0.9. In the formula (8), R₁ is a hydrogen or a C₁₋₁₀ alkyl group and may be the same or different in each of the repeat units, R₈, R₉ and R₁₁ are different from each other and are one of a carboxylic acid group, a C₁₋₁₀ alkyl ester group, a C₃₋₁₀ cycloalkyl ester group or a C₇₋₁₀ aralkyl ester group or a C₂₋₁₀ fluoroalkyl ester group.

In an exemplary embodiment, the random copolymer of the surface modification layer can comprise three different repeat units and has the structure of formula (10):

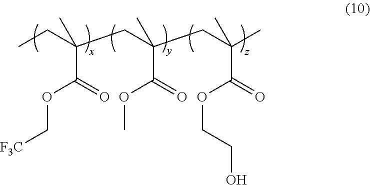

wherein mole fraction x is 0.01 to 0.99, specifically 0.05 to 0.95; mole fraction y is 0.99 to 0.01, specifically 0.95 to 0.05; and mole fraction z is 0.001 to 0.1, specifically 0.01 to 0.04; and the sum of mole fractions x, y, and z is 1.

In another exemplary embodiment, the random copolymer of the surface modification layer can comprise three different repeat units and has the structure of formula (11):

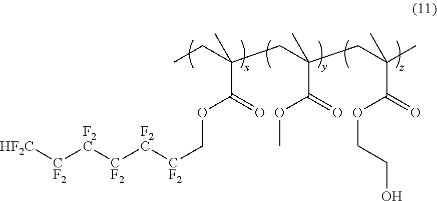

wherein mole fraction x is 0.01 to 0.99, specifically 0.05 to 0.95; mole fraction y is 0.99 to 0.01, specifically 0.95 to 0.05; and mole fraction z is 0.001 to 0.1, specifically 0.01 to 0.04; and the sum of mole fractions x, y, and z is 1. Exemplary random copolymers are copoly(methyl methacrylate-ran-trifluoroethyl methacrylate) and copoly(methyl methacrylate-ran-do decafluoroheptylmethacrylate), where the “ran” indicates a random copolymer.

In one embodiment, the random copolymer is a number averaged molecular weight of 10,000 to 80,000 g/mole and a polydispersity index of less than or equal to 1.3.

The random copolymer can also comprise blends of copolymers. In one embodiment, a first random copolymer having the formula shown in the structure (4) can be blended with a second random copolymer having the formula shown in the structure (4), where the first random copolymer is not identical with the second random copolymer. Three or more random copolymers can also be blended with each other (so long as each has a structure that is different from the other two) to form the surface medication film In another embodiment, a first random copolymer having the formula shown in the structure (7) can be blended with a second random copolymer having the formula shown in the structure (7), where the first random copolymer is not identical with the second random copolymer. In yet another embodiment, a first random copolymer having the formula shown in the structure (4) can be blended with a second random copolymer having the formula shown in the structure (7). The first random copolymer is generally present in an amount of 10 to 90 wt %, while the second random copolymer is present in an amount of 10 to 90 wt %, based on the total weight of the blend of copolymers. Blends of random copolymers will hereinafter be included in the term “random copolymer”.

The random copolymer is generally disposed upon the surface of a substrate to form the surface modification layer by methods that comprise dissolving or dispersing it in a solvent. The solvent can be a polar solvent, a non-polar solvent or a combination thereof. Exemplary solvents may include 1-methoxy-2-propanol, 1-methoxy-2-propyl acetate, ethyl lactate, anisole, cyclohexanone, 2-heptanone, diacetonealcohol, toluene, trifluorotoluene, or a combination comprising at least one of the foregoing. The random copolymer is dissolved in a concentration that is effective to form a coating on the surface of the substrate. The coating is formed by methods that include spin casting, dip coating, spray drying, or by application via a doctor blade.

The concentration of the random copolymer prior to deposition on the surface of the substrate is less than or equal to 40 wt %, based upon the weight of the random copolymer and the solvent. In one embodiment, the concentration of the random copolymer prior to deposition on the surface of the substrate is 1 to 35 wt %, specifically 5 to 30 wt %, and more specifically 10 to 25 wt %, based upon the weight of the random copolymer and the solvent.

Substrates used for disposing the surface modification layer include any substrate having a surface that can be coated with the copolymer composition of the present invention. Preferred substrates include layered substrates. Preferred substrates include silicon containing substrates (e.g., glass; silicon dioxide; silicon nitride; silicon oxynitride; silicon containing semiconductor substrates such as silicon wafers, silicon wafer fragments, silicon on insulator substrates, silicon on sapphire substrates, epitaxial layers of silicon on a base semiconductor foundation, silicon-germanium substrates); plastic; metals (e.g., copper, ruthenium, gold, platinum, aluminum, titanium and alloys); titanium nitride; and non-silicon containing semiconductive substrates (e.g., non-silicon containing wafer fragments, non-silicon containing wafers, germanium, gallium arsenide and indium phosphide). An exemplary substrate is a silicon containing substrate.

As detailed above, a block copolymer is disposed upon the surface modification layer to produce blocks that are perpendicular to the surface of the substrate. By selecting a block copolymer whose surface energy differs as minimally as possible from the surface energy of the surface modification layer, the domain sizes, the domain geometry and the inter-domain spacing can be carefully controlled. It is desirable to select a block copolymer having a number average molecular weight for each block that enables the block copolymeric film to form lamellar or cylindrical domains having a perpendicular orientation to the surface of the substrate upon which the block copolymer is disposed.

Block copolymers are polymers that are synthesized from two or more different monomers and exhibit two or more polymeric chain segments that are chemically different, but yet, are covalently bound to one another. Diblock copolymers are a special class of block copolymers derived from two different monomers (e.g., A and B) and having a structure comprising a polymeric block of A residues covalently bound to a polymeric block of B residues (e.g., AAAAA-BBBBB).

The blocks can in general be any appropriate domain-forming block to which another, dissimilar block can be attached. Blocks can be derived from different polymerizable monomers, where the blocks can include but are not limited to: polyolefins including polydienes, polyethers including poly(alkylene oxides) such as poly(ethylene oxide), polypropylene oxide), poly(butylene oxide), or random or block copolymers of these; poly((meth)acrylates), polystyrenes, polyesters, polyorganosiloxanes, or polyorganogermanes.

In one embodiment, the blocks of the block copolymer comprise as monomers C₂₋₃₀ olefinic monomers, (meth)acrylate monomers derived from C₁₋₃₀ alcohols, inorganic-containing monomers including those based on iron, silicon, germanium, tin, aluminum, titanium, or a combination comprising at least one of the foregoing monomers. In a specific embodiment, exemplary monomers for use in the blocks can include, as the C₂₋₃₀ olefinic monomers, ethylene, propylene, 1-butene, 1,3-butadiene, isoprene, vinyl acetate, dihydropyran, norbornene, maleic anhydride, styrene, 4-hydroxy styrene, 4-acetoxy styrene, 4-methylstyrene, or a-methylstyrene; and can include as (meth)acrylate monomers, methyl(meth)acrylate, ethyl(meth)acrylate, n-propyl(meth)acrylate, isopropyl(meth)acrylate, n-butyl(meth)acrylate, isobutyl(meth)acrylate, n-pentyl(meth)acrylate, isopentyl(meth)acrylate, neopentyl(meth)acrylate, n-hexyl(meth)acrylate, cyclohexyl(meth)acrylate, isobornyl(meth)acrylate, or hydroxyethyl(meth)acrylate. Combinations of two or more of these monomers can be used.

Exemplary blocks which are homopolymers can include blocks prepared using styrene (i.e., polystyrene blocks), or (meth)acrylate homopolymeric blocks such as poly(methylmethacrylate); exemplary random blocks include, for example, blocks of styrene and methyl methacrylate (e.g., poly(styrene-co-methyl methacrylate)), randomly copolymerized; and an exemplary alternating copolymer block can include blocks of styrene and maleic anhydride which is known to form a styrene-maleic anhydride diad repeating structure due to the inability of maleic anhydride to homopolymerize under most conditions (e.g., poly(styrene-alt-maleic anhydride)). It will be understood that such blocks are exemplary and should not be considered to be limiting.

Exemplary block copolymers that are contemplated for use in the present method include diblock or triblock copolymers such as poly(styrene-b-vinyl pyridine), poly(styrene-b-butadiene), poly(styrene-b-isoprene), poly(styrene-b-methyl methacrylate), poly(styrene-b-alkenyl aromatics), poly(isoprene-b-ethylene oxide), poly(styrene-b-(ethylene-propylene)), poly(ethylene oxide-b-caprolactone), poly(butadiene-b-ethylene oxide), poly(styrene-b-t-butyl(meth)acrylate), poly(methyl methacrylate-b-t-butyl methacrylate), poly(ethylene oxide-b-propylene oxide), poly(styrene-b-tetrahydrofuran), poly(styrene-b-isoprene-b-ethylene oxide), poly(styrene-b-dimethylsiloxane), poly(styrene-b-trimethylsilylmethyl methacrylate), poly(methyl methacrylate-b-dimethylsiloxane), poly(methyl methacrylate-b-trimethylsilylmethyl methacrylate), or the like, or a combination comprising at least one of the foregoing block copolymers.

In one embodiment, the block copolymer comprises a polysiloxane block and a non-polysiloxane block. An exemplary block copolymer is polystyrene-polydimethylsiloxane, hereinafter termed poly(styrene)-b-poly(dimethylsiloxane) and designated as PS-b-PDMS.

The poly(styrene)-b-poly(dimethylsiloxane) block copolymer composition disclosed herein comprises a poly(styrene)-b-poly(dimethylsiloxane) block copolymer component, wherein the poly(styrene)-b-poly(dimethylsiloxane) block copolymer component is selected from a single PS-b-PDMS block copolymer or from a blend of at least two different PS-b-PDMS block copolymers; wherein the average molecular weight of the poly(styrene)-b-poly(dimethylsiloxane) block copolymer component is 25 to 1,000 kg/mol, specifically 30 to 1,000; more specifically 30 to 100; and most specifically 30 to 60 kg/mol.

In one embodiment, the poly(styrene)-b-poly(dimethylsiloxane) block copolymer component is a single PS-b-PDMS block copolymer; wherein the average molecular weight (as defined hereinabove) of the PS-b-PDMS block copolymer is 25 to 1,000 kg/mol (specifically 30 to 1,000 kg/mol; more specifically 30 to 100; most specifically 30 to 60 kg/mol). In another embodiment, the poly(styrene)-b-poly(dimethylsiloxane) component is a blend of at least two different PS-b-PDMS block copolymers; wherein the average molecular weight (as defined hereinabove) of the blend of PS-b-PDMS block copolymers is 25 to 1,000 kg/mol, specifically 30 to 1,000 kg/mol; more specifically 30 to 100; most specifically 30 to 60 kg/mol. In an exemplary embodiment, the poly(styrene)-b-poly(dimethylsiloxane) block copolymer component is a blend of at least two different PS-b-PDMS block copolymers; wherein the at least two different PS-b-PDMS block copolymers are selected from PS-b-PDMS block copolymers having a number average molecular weight, Mₙ, of 1 to 1,000 kg/mol; a polydispersity, PD, of 1 to 3, specifically 1 to 2, most specifically 1 to 1.2; and, a poly(dimethylsiloxane) weight fraction, Wf_{PDMS}, of 0.18 to 0.8, specifically 0.18 to 0.35 when the desired morphology comprises polydimethylsiloxane cylinders in a polystyrene matrix; and 0.22 to 0.32, specifically 0.35 to 0.65 when the desired morphology comprises polydimethylsiloxane lamellae in a polystyrene matrix; and 0.4 to 0.6, specifically 0.65 to 0.8, and more specifically 0.68 to 0.75 when the desired morphology is polystyrene-cylinders in a polydimethylsiloxane matrix.

The block copolymer desirably has an overall molecular weight and polydispersity amenable to further processing. In an embodiment, the block copolymer has a weight-averaged molecular weight (Mw) of 10,000 to 200,000 g/mol. Similarly, the block copolymer has a number averaged molecular weight (Mn) of 5,000 to 200,000. The block copolymer can also have a polydispersity (Mw/Mn) of 1.01 to 6. In an embodiment, the polydispersity of the block copolymer is 1.01 to 1.5, specifically 1.01 to 1.2, and still more specifically 1.01 to 1.1. Molecular weight, both Mw and Mn, can be determined by, for example, gel permeation chromatography using a universal calibration method, and calibrated to polystyrene standards.

The poly(styrene)-b-poly(dimethylsiloxane) block copolymer composition used in the method of the present invention, optionally further comprises a solvent. Solvents suitable for use in the poly(styrene)-b-poly(dimethylsiloxane) block copolymer composition include liquids that are able to disperse the poly(styrene)-b-poly(dimethylsiloxane) block copolymer component into particles or aggregates having an average hydrodynamic diameter of less than 50 nanometers (nm) as measured by dynamic light scattering. Specifically, the solvent used is selected from propylene glycol monomethyl ether acetate (PGMEA), ethoxyethyl propionate, anisole, ethyl lactate, 2-heptanone, cyclohexanone, amyl acetate, γ-butyrolactone (GBL), n-methylpyrrolidone (NMP) and toluene. More specifically, the solvent used is selected from propylene glycol monomethyl ether acetate (PGMEA) and toluene. Most specifically, the solvent used is toluene.

The poly(styrene)-b-poly(dimethylsiloxane) block copolymer composition used in the method of the present invention, optionally further comprises an additive. Preferred additives for use in the poly(styrene)-b-poly(dimethylsiloxane) block copolymer composition include surfactants and antioxidants. Additional polymers (including homopolymers and random copolymers); surfactants; antioxidants; photoacid generators; thermal acid generators; quenchers; hardeners; adhesion promoters; dissolution rate modifiers; photocuring agents; photosensitizers; acid amplifiers; plasticizers; and cross linking agents. Preferred additives for use in the poly(styrene)-b-poly(dimethylsiloxane) block copolymer composition include surfactants and antioxidants.

In one embodiment, in one method of disposing the block copolymer film on the surface of the substrate, the substrate is optionally cleaned by washing it with a suitable solvent for removing contaminants. The surface of the substrate is then pretreated with the surface modification layer before the block copolymer composition is applied to the surface modification layer. After the application of the surface modification layer, but prior to the application of the block copolymer composition, the surface modification layer may be washed to remove any unreacted species and contaminants.

As detailed above, the surface modification layer is disposed by spin coating, spray drying, dip coating, and the like. The surface modification layer may be reacted to the surface of the substrate to form brushes or alternatively, the surface modification layer can be cured using either thermal energy and/or electromagnetic radiation. Ultraviolet radiation can be used to cure the surface modification layer. Activators and initiators can be used to vary the curing characteristics of the surface modification film.

The surface modification layer acts like a tying layer interposed between the surface of the substrate and the block copolymer composition to enhance the adhesion between the block copolymer composition and the substrate.

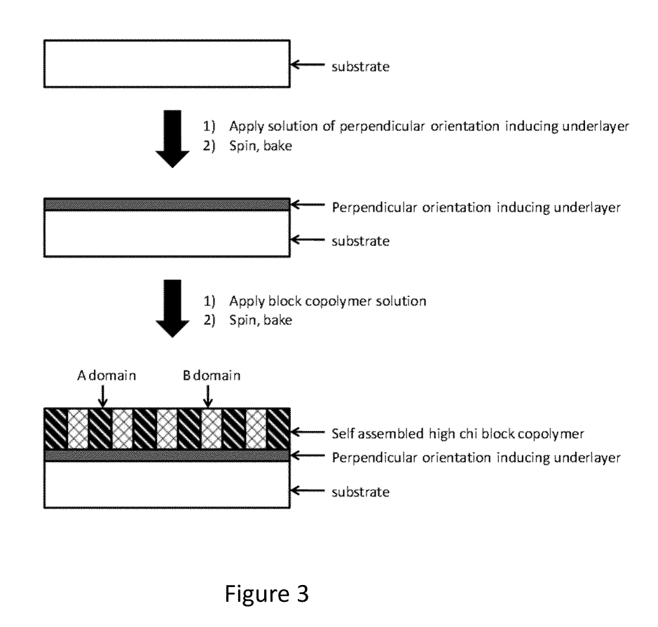

The block copolymer is, in an embodiment, spin cast from a solution onto the perpendicular orientation inducing surface modification layer to form a self-assembling layer on the surface of the surface modification layer as described in the FIG. 3. In one embodiment, the substrate with the surface modification layer and the block copolymer layer disposed thereon is heated to a temperature of up to 350° C. for up to 4 hours to both remove solvent and form the domains in an annealing process. The domains form with a perpendicular orientation to the substrate. A relief pattern is then formed by removing either the first or second domain to expose an underlying portion of the surface modification layer or of the substrate. In an embodiment, the removing is accomplished by a wet etch method, developing, or a dry etch method using a plasma such as an oxygen or CF₄ plasma.

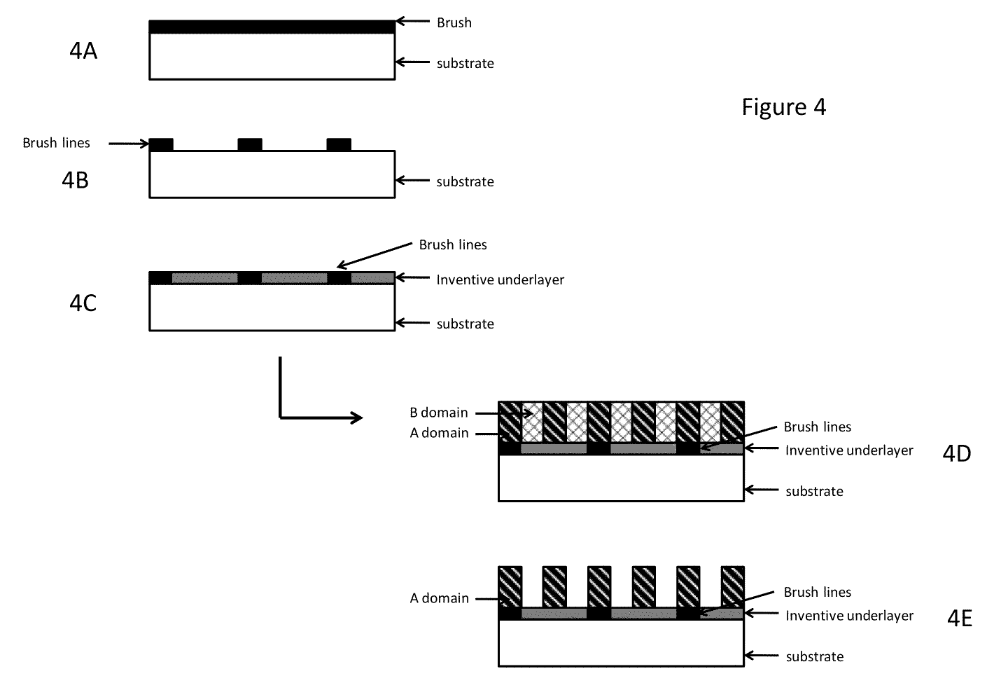

In another embodiment, the block copolymer is spin cast from a solution onto a patterned surface comprising features of a perpendicular orientation inducing surface modification layer and a second material designed to “pin” or selectively interact with the first or second block as illustrated in FIG. 4. The second material would be one that interacts with the higher energy block of the block copolymer, such as for example, e.g. the polystyrene block of the polystyrene-polydimethylsiloxane copolymer. This could be for example a polystyrene brush and/or mat, or another material with similar characteristics to polystyrene.

In this embodiment depicted in the FIG. 4A, a first surface modification layer is disposed upon the surface of the substrate and reacted to the surface to form a brush layer. Portions of the brush layer are removed via chemical or plasma etching or by another method as depicted in the FIG. 4B. A second surface modification layer is then disposed upon the surface of the substrate in those regions which do not contain the brush layer as depicted in the FIG. 4C. This second surface modification layer is then crosslinked or reacted with the surface of the substrate. The block copolymer is then disposed upon the surface of the surface modification layers to form a copolymer film whose blocks are perpendicular in orientation to the surface of the substrate as seen in the FIG. 4D.

The block copolymer is heated to a temperature of up to 350° C. for up to 4 hours to both remove solvent and form the domains in an annealing process. The domains form perpendicular to the substrate and the first block aligns to the pattern created on the first domain to the “pinning” feature on the substrate, and the second block forms a second domain on the substrate aligned adjacent to the first domain. Where the patterned substrate forms a sparse pattern, and hence the surface modification layer regions are spaced at an interval greater than an interval spacing of the first and second domains, additional first and second domains form on the surface modification layer to fill the interval spacing of the sparse pattern. The additional first domains, without a pinning region to align to, instead align perpendicular to the previously formed perpendicular orientation inducing surface modification layer, and additional second domains align to the additional first domains.

One of the domains of the block copolymer is then etched away as seen in the FIG. 4E. A relief pattern is then formed by removing either the first or second domain to expose an underlying portion of the brush layer. In an embodiment, removing is accomplished by a wet etch method, developing, or a dry etch method using a plasma such as an oxygen plasma. The block copolymer with at least one domain removed is then used as a template to decorate or manufacture other surfaces that may be used in fields such as electronics, semiconductors, and the like.

The perpendicular orientation control surface modification layer can also be made into a pattern formed to direct the self-assembly may have features which form a regular pattern with a dense pitch, i.e., a ratio of line width to space width of 1:1 or more (e.g., 1.1:1, 1.2:1, 1.5:1, 2:1, and the like), a semi-dense pitch of less than 1:1 (e.g., 1:1.5) or a sparse pattern having a pitch of 1:2 or less (e.g., 1:3, 1:4, and the like).

A sparse pattern can be formed on the surface of the surface modification layer using low resolution techniques such as patterns of dashes or dots, rather than using contiguous patterns as would be obtained using unbroken lines. Upon forming the domains on these patterns, the domains align to dashes and/or dots as well as to lines, and due to the ability of domains to align with regularity of size and shape to domains formed on the intermittent patterned regions, the aligned domains can form patterns comparable to those formed on contiguous patterns.

In another embodiment, the surface modification layers can be incorporated into the methods described by Cheng et al. in U.S. Pat. No. 7,521,094 and related methods to form chemical patterns for directing the block copolymer self-assembly. The surface modification layers can also be applied to the bottom of trenches in graphoepitaxy substrates to promote stable perpendicular orientations of lamellar block copolymers guided by trench substrates.

Advantageously, use of lines or dashes with high line-edge roughness and line-width roughness is tolerated by this patterning method, as the domains upon forming can correct any defects of alignment in a “self-healing” mechanism during annealing. In addition, for applications involving electron-beam lithography, writing dashed lines and/or dotted lines takes less writing time (and/or requires a lower energy dose) than writing a solid line. Thus, in an embodiment, the pattern can be non-contiguous, comprising dashes and/or dots. The spacing and alignment of the dashes and/or dots are such that domains formed on the non-contiguous pattern assemble to form a contiguous pattern of domains in which the incidence of defects is minimized.

In one embodiment, at least one microphase-separated domain is selectively removed to generate a topographical pattern, followed by pattern transfer from the topographic pattern to another substrate by a reactive ion etch process. The other substrate may be a semiconductor substrate. The above methods and structures may be used in the manufacture of semiconductor devices including memory devices requiring dense line/space patterns such as synchronous dynamic random access memory (SDRAM) or dense features for data storage such as in hard drives.

The methods and compositions disclosed herein display a number of advantages. In one embodiment, the perpendicular orientation inducing surface modification layer compositions for stable perpendicular PS-b-PDMS morphologies are not based on random copolymers of PS and PDMS, which would make transfer of the patterns difficult as the perpendicular orientation inducing surface modification layer would be converted to an etch resistant “silica-like” material upon exposure to oxygen plasma during removal of the PS phase. Instead, the orientation control surface modification layers incorporate compositions based on blocks with high O₂ plasma etch rates, such as organic (meth)acrylates.

The surface modification layers can also be advantageously used to stabilize cylinder-forming PS-PDMS materials to create arrays of perpendicularly oriented PS or PDMS posts rather than parallel cylinders as is typically observed with cylinder forming PS-PDMS materials.

The methods as disclosed allow for formation of self-assembling preparation of nanoscale structural features, and directional control of the nanopatterned features, by sequential deposition of the orientation control surface modification layer using often used solution coating techniques, providing greater control of the desired feature patterns, into different post-patterning processes useful for obtaining different topographies by substrate etch, and for the preparation of a wide variety of features in a wide variety of compositional or topographic substrates.

The invention is further illustrated by the following non-limiting examples.

### EXAMPLES

Solvents and chemicals were obtained from standard commercial sources and used as received unless indicated otherwise. Methyl methacrylate (MMA), trifluoroethyl methacrylate, and dodecafluoroheptylmethacrylate were filtered through basic alumina and were used to form the random copolymer used in the surface modification layer.

Molecular weight and polydispersity values were measured by gel permeation chromatography (GPC) on an Agilent 1100 series LC system equipped with an Agilent 1100 series refractive index and MiniDAWN light scattering detector (Wyatt Technology Co.). Samples were dissolved in HPCL grade THF at a concentration of approximately 1 mg/mL and filtered through at 0.20 μm syringe filter before injection through the two PLGel 300×7.5 mm Mixed C columns (5 mm, Polymer Laboratories, Inc.). A flow rate of 1 mL/min and temperature of 35° C. were maintained. The columns were calibrated with narrow molecular weight PS standards (EasiCal PS-2, Polymer Laboratories, Inc.).

Proton NMR spectroscopy was done on a Varian INOVA 400 MHz NMR spectrometer. Deuterated tetrahydrofuran was used for all NMR spectra. A delay time of 10 seconds was used to ensure complete relaxation of protons for quantitative integrations. Chemical shifts were reported relative to tetramethylsilane (TMS).

Contact angle was measured on a contact angle goniometer by the Sessile Drop method using water (18 ohm deionized water), methylene iodide (CH₂I₂), and diethylene glycol. Surface energy including both polar and dispersive components was calculated from the contact angles of each of these solvents using the Owens-Wendt method. The results are reported in units of milliNewton per meter (mN/m).

The following examples were conducted to demonstrate the method of manufacturing the surface modification layer and the formation of the block copolymer having blocks that are perpendicular to the surface of the substrate. Three different random copolymers were manufactured for the examples and these are described below. A hydroxyl-terminated polystyrene brush was also manufactured for use in the examples and the preparation of this brush is described below. Polystyrene-polydimethylsiloxane block copolymers were also synthesized (PS-PDMS-A or PS-PDMS-C) or purchased (PS-PDMS-B or PS-PDMS-D) for the examples and the synthesis of these is described below. Details of the polystyrene-polysiloxane block copolymers that were purchased is also provided below.

A hydroxyl-terminated polystyrene brush was prepared by first adding cyclohexane (1,500 g) into a 2 liter glass reactor under a nitrogen atmosphere was added. Styrene (50.34 g) was then added to the reactor via cannula. The contents of the reactor were then heated to 40° C. Sec-butyllithium (19.18 g) diluted in cyclohexane to a concentration of 0.32 M was then rapidly added to the reactor via a cannula causing the reactor contents to turn yellow. The contents of the reactor were stirred for 30 minutes. The contents of the reactor were then cooled to 30° C. Ethylene oxide (0.73 g) was then transferred into the reactor. The contents of the reactor were stirred for 15 minutes. Then a 20 mL of a 1.4 M solution of HCl in methanol was added to the reactor. The polymer in the reactor was then isolated by precipitating into isopropanol at a ratio of 500 mL of polymer solution to 1,250 mL of isopropanol. The resulting precipitate was then filtered and dried overnight in a vacuum oven at 60° C., yielding 42 g of product hydroxyl-terminated polystyrene. The product hydroxyl-terminated polystyrene exhibited a number average molecular weight, Mₙ, of 7.4 kg/mol and a polydispersity index, PD, of 1.07. The polystyrene brush was used in Comparative Example Nos. 1 and 2.

The polystyrene-polydimethylsiloxane blocks have the following designations and characteristics and were used in several different examples as detailed below: PS-PDMS-B, with Mₙ=25.5 kg/mol, polydispersity index, PD, of 1.08, and 33 wt % PDMS, and PS-PDMS-D, with Mₙ=43 kg/mol, polydispersity index, PD, of 1.08, and 49 wt % PDMS, were purchased from Polymer Source and used as received.

PS-PDMS-A (Mₙ=40 kg/mol, 22 wt % PDMS) was prepared by first adding cyclohexane (56 g) and styrene (16.46 g) to a 500 mL round bottom reactor under an argon atmosphere. The contents of the reactor were then warmed to 40° C. A 7.49 g shot of a 0.06 M solution of sec-butyllithium in cyclohexane was then rapidly added to the reactor via cannula, causing the reactor contents to turn yellow-orange. The reactor contents were allowed to stir for 30 minutes. A small portion of the reactor contents was then withdrawn from the reactor into a small round bottomed flask containing anhydrous methanol for gel permeation chromatography analysis of the polystyrene block formed. Then 22.39 g of a 21 wt % solution of freshly sublimed hexamethylcyclotrisiloxane in cyclohexane was transferred to the reactor. The reactor contents were allowed to react for 20 hours. Then dry tetrahydrofuran (93 mL) was added to the reactor and the reaction was allowed to proceed for 7 hours. Chlorotrimethylsilane (1 mL) was then added to the reactor to quench the reaction. The product was isolated by precipitating into 1 L of methanol and filtering. After washing with additional methanol, the polymer was re-dissolved in 150 mL of methylene chloride, washed twice with deionized water and then reprecipitated into 1 L of methanol. The polymer was then filtered and dried overnight in a vacuum oven at 60° C., yielding 19.7 g. The PS-PDMS block copolymer (PS-PDMS-A) product exhibited a number average molecular weight, Mₙ, of 40 kg/mol; a polydispersity, PD, of 1.1 and a 22 wt % PDMS content (as determined by ¹H NMR).

PS-PDMS-C was prepared substantially according to the method described for PS-PDMS-A to yield a material with a number average molecular weight, M_{N}, of 24.2 kg/mol; a polydispersity, PD, of 1.1 and a 45 wt % PDMS content (as determined by ¹H NMR).

The first random copolymer was prepared using methyl methacrylate and trifluoroethyl methacrylate. Random copoly(methyl methacrylate-ran-trifluoroethyl methacrylate) with a reactive alcohol end group was first prepared by adding to a Schlenk flask equipped with a magnetic stirring bar, 4,4′-di-tert-butyl-2,2′-bipyridyl (0.537 gram (g)), Cu(I)Br (0.144 g), methyl methacrylate (9.50 g), trifluoroethyl methacrylate (0.50 g), and toluene (10 g). The solution was sparged with argon for 15 minutes and then placed in a preheated oil bath at 90° C. Once the solution had come to equilibrium, the initiator (2-hydroxyethyl 2-bromo-2-methylpropanoate) (0.211 g) was added via syringe and the reaction was stirred at 90° C. After the polymerization was quenched, the mixture was diluted with tetrahydrofuran (THF) and stirred with ion exchange beads to remove the catalyst. Once the solution was clear, it was filtered, concentrated to 50 wt %, and precipitated into excess cyclohexane. The polymer was collected and dried in a vacuum oven at 60° C. overnight. ¹H NMR showed the polymer to have a composition of 95 wt % methyl methacrylate and 5 wt % trifluoroethyl methacrylate. Gel-permeation chromatography revealed a number average molecular weight (Mn)=11.8 kg/mol relative to PS standards and Mw/Mn=1.22.

The second random copolymer comprising copoly(methyl methacrylate-ran-trifluoroethyl methacrylate) was manufactured with a reactive alcohol end group by adding to a Schlenk flask equipped with a magnetic stirring bar, 4,4′-di-tert-butyl-2,2′-bipyridyl (0.537 g), Cu(I)Br (0.144 g), methyl methacrylate (7.00 g), trifluoroethyl methacrylate (3.00 g), and toluene (10 g). The solution was sparged with argon for 15 minutes and then placed in a preheated oil bath at 90° C. Once the solution had come to equilibrium, the initiator (2-hydroxyethyl 2-bromo-2-methylpropanoate) (0.211 g) was added via syringe and the reaction was stirred at 90° C. After the polymerization was quenched, the mixture was diluted with THF and stirred with ion exchange beads to remove the catalyst. Once the solution was clear, it was filtered, concentrated to 50 wt %, and precipitated into excess cyclohexane. The polymer was collected and dried in a vacuum oven at 60° C. overnight. ¹H NMR showed the polymer to have a composition of 69 wt % methyl methacrylate and 31 wt % trifluoroethyl methacrylate. Gel-permeation chromatography revealed a Mn=13.9 kg/mol relative to polystyrene (PS) standards and Mw/Mn=1.20.

The third random copolymer comprising random copoly(methyl methacrylate-ran-do decafluoroheptylmethacrylate) was manufactured with a reactive alcohol end group by adding to a Schlenk flask equipped with a magnetic stirring bar, 4,4′-di-tert-butyl-2,2′-bipyridyl (0.537 g), Cu(I)Br (0.143 g), methyl methacrylate (1.02 g), dodecafluoroheptylmethacrylate (9.05 g), and toluene (10 g) were added. The solution was sparged with argon for 15 minutes and then placed in a preheated oil bath at 90° C. Once the solution had come to equilibrium, the initiator (2-hydroxyethyl 2-bromo-2-methylpropanoate) (0.210 g) was added via syringe and the reaction was stirred at 90° C. After the polymerization was quenched, the mixture was diluted with THF and stirred with ion exchange beads to remove the catalyst. Once the solution was clear, it was filtered, concentrated to 50 wt %, and precipitated into excess cyclohexane. The polymer was collected and dried in a vacuum oven at 60° C. overnight. ¹H NMR showed the polymer to have a composition of 7 wt % methyl methacrylate and 93 wt % dodecafluoroheptylmethacrylate. Gel-permeation chromatography revealed a Mn=14.9 kg/mol relative to PS standards and Mw/Mn=1.27.

The three random copolymers detailed above were then cast onto a substrate and the surface energy was determined for each of the random copolymers using a contact angle determination method. The contact angle was measured on a contact angle goniometer by the Sessile drop method using water (18 ohm deionized water), methylene iodide (CH₂I₂), and diethylene glycol. Surface energy including both polar and dispersive components was calculated from the contact angles of each of these solvents using the Owens-Wendt method. The results are reported in units of millijoules per square meter (mJ/m²) or nilliNewtons/meter (mN/m).

The Table 1 below shows the surface energy of the respective random copolymers as well as the contributions from the polar and dispersive components of surface energy.

TABLE 1

| | Total | | | |
|---|---|---|---|---|
| | Surface | | | |
| | energy | Polar | Dispersive | Polarity |
| Random Copolymer | (mN/m) | (mN/m) | (mN/m) | (%) |
| (Sample #1) | 36.9 | 10.87 | 26.07 | 29.4 |
| copoly(methyl methacrylate-ran- | | | | |
| trifluoroethyl methacrylate) | | | | |
| (Sample #2) | 31.7 | 8.12 | 23.54 | 25.7 |
| copoly(methyl methacrylate-ran- | | | | |
| trifluoroethyl methacrylate) | | | | |
| (Sample #3) | 20.9 | 2.68 | 18.24 | 12.8 |
| copoly(methyl methacrylate-ran- | | | | |
| dodecafluoroheptylmethacrylate) | | | | |

As seen in Table 1, the random copolymers have a range of surface energies that can be tailored by modifying the composition of the copolymer or by selecting different functional groups. From the Table 1 it may also be se that the total surface energy of the surface modification layer has a total surface energy of 15 to 50 mN/m. The three copolymers shown in the Table 1 were then used as surface modification layers in Examples 1-3, which are detailed below.

### Comparative Example No. 1

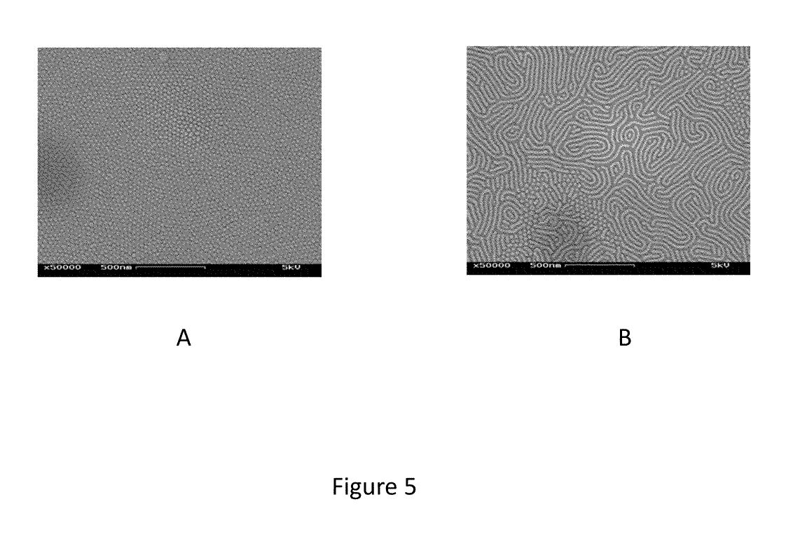

This example was conducted to depict the orientation of polydimethylsiloxane (PDMS)-cylinder forming PS-b-PDMS on a silicon substrate that has polystyrene brushes disposed on it. Polystyrene brush coated silicon substrates were prepared by spin coating a solution of hydroxyl-end functionalized polystyrene brush (7.4 kg/mol) in toluene. The substrates were baked at 250° C. for 20 minutes and the excess ungrafted polystyrene brushes were then removed by washing with excess toluene. Thin films of PS-PDMS (PS-PDMS-A, Mn=40 kg/mol, 22 wt % PDMS) were then cast on the coated substrates from propylene glycol methyl ether acetate (PGMEA) solution at the desired thicknesses (t_{f}=46.7 nanometers for FIG. 5A, and 48.9 nanometers for FIG. 5B), baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. When annealed at relatively low temperatures, for example 200° C. for 1 hour the orientation of the PDMS cylinders is perpendicular to the surface of the substrate. In other words, the longitudinal axis of the cylinder is parallel to a perpendicular drawn to the surface. FIG. 5A is a photomicrograph showing the orientation of the film after annealing at 200° C. for 1 hour. However, with annealing at 290° C. for 1 hour, the orientation switches to parallel (i.e., the longitudinal axis of the cylinders is perpendicular to a perpendicular drawn to the surface) as evidenced by the presence of the characteristic “fingerprint” pattern that can be seen in the micrograph in the FIG. 5B.

### Comparative Example No. 2

This example was conducted to demonstrate the orientation of PDMS-cylinder forming PS-b-PDMS blend on a PS brushed substrate. Polystyrene brush coated silicon substrates were prepared by spin coating a solution of hydroxyl-end functionalized polystyrene brushes (7.4 kg/mol) in toluene. The substrates were baked at 250° C. for 20 minutes, and the excess ungrafted brush was then removed by washing with excess toluene. Thin films of a 1:1 wt/wt blend of two different PS-PDMS (PS-PDMS-A, Mn=40 kg/mol, 22 wt % PDMS, and PS-PDMS-B, Mn=25.5 kg/mol, 33 wt % PDMS) were then cast on the coated substrates from propylene glycol methyl ether acetate (PGMEA) solution at the desired thicknesses, baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. Again, when annealed at relatively low temperatures, the orientation of the PDMS cylinders is perpendicular but switches to parallel “fingerprint” morphology with annealing at 340° C. for 1 hour in a film. The photomicrographs with the respective orientations are not shown here.

### Example No. 1

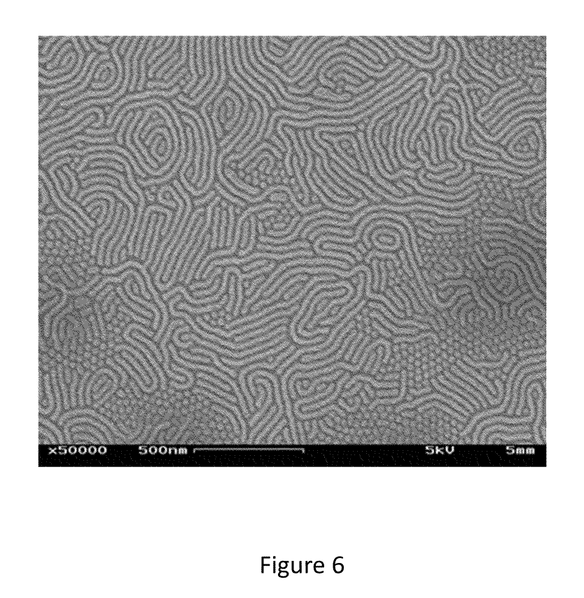

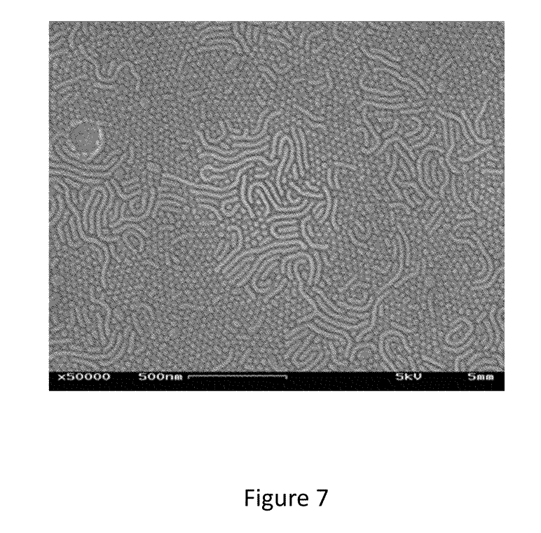

This example was conducted to demonstrate control of the orientation of the PDMS-cylinder forming PS-b-PDMS on the random copolymer copoly(methyl methacrylate-ran-trifluoroethyl methacrylate) (Sample #1). The random copolymer was coated onto silicon substrates by spin coating at 1.5 wt % in toluene at 3000 rpm. The random copolymer forms a surface modification layer that has brush-lie characteristics. The substrates were baked at 250° C. for 20 minutes, and the excess ungrafted copolymer was then removed by washing with excess toluene. PS-PDMS-A (Mn=40 kg/mol, 22 wt % PDMS) block copolymer was then cast on the coated substrates from propylene glycol methyl ether acetate (PGMEA) solution at a thickness of 40 nm, baked at 150° C. for 1 min to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. FIG. 6 shows the block copolymer morphology disposed on the random copolymer after annealing at 290° C. for 1 hour, which shows the fingerprint morphology consistent with preferential wetting. The fingerprint morphology is representative of cylindrical domains whose longitudinal axis is perpendicular to a perpendicular drawn to the surface of the substrate.

### Example No. 2

This example was conducted to demonstrate control of the orientation of the PDMS-cylinder forming PS-b-PDMS on the random copolymer copoly(methyl methacrylate-ran-trifluoroethyl methacrylate) (Sample #2). The random copolymer was coated onto silicon substrates by spin coating a solution at 1.5 wt % in toluene at 3000 rpm. The surface modification layer formed a brush-like surface on the surface of the substrate. The substrates were baked at 250° C. for 20 minutes, and the excess ungrafted copolymer was then removed by washing with excess toluene. PS-PDMS-A (Mn=40 kg/mol, 22 wt % PDMS) block copolymer was then cast on the coated substrates from propylene glycol methyl ether acetate (PGMEA) solution to form a film having a thickness of 38 nm (on the surface modification layer), baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. Error! Reference source not found. 7 shows the thin film morphology on the random copolymer surface modification layer after annealing at 290° C. for 1 hour which reveals a mixture of parallel and perpendicular cylinders.

### Example No. 3

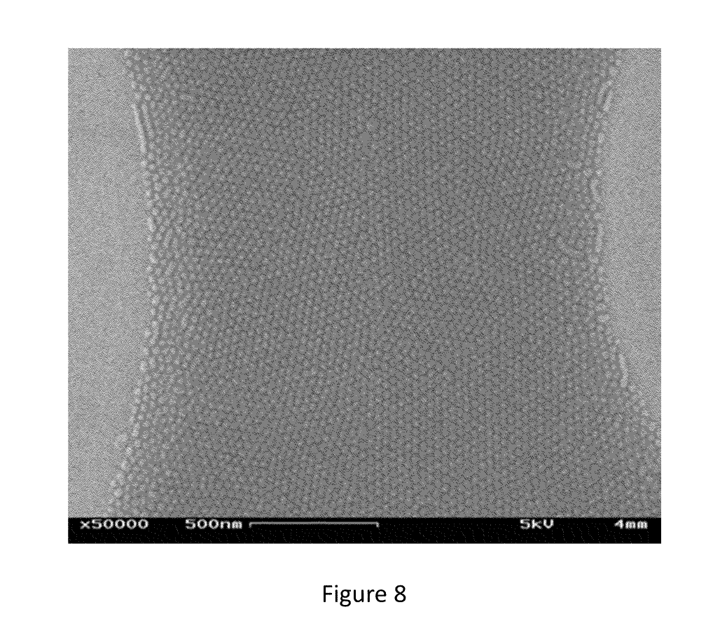

This example was conducted to demonstrate control of the orientation of the PDMS-cylinder forming PS-b-PDMS on the random copolymer copoly(methyl methacrylate-ran-do decafluoroheptylmethacrylate) (Sample #3). The surface modification layer was coated onto silicon substrates by spin coating a solution at 1.5 wt % in trifluorotoluene at 3000 rpm. The random copolymer formed a brush-lie surface modification layer on the surface of the substrate. The substrates were baked at 250° C. for 20 minutes, and the excess ungrafted copolymer was then removed by washing with excess trifluorotoluene. Thin films of PS-PDMS-D, (Mn=43 kg/mol, 49% PDMS) were then cast on the coated substrates from propylene glycol methyl ether acetate (PGMEA) solution at a thickness of 40 nm, baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged using scanning electron microscopy to determine domain orientation. The morphology shown in the FIG. 8 shows entirely perpendicular cylinders with no sign of parallel cylinder morphology. This indicates that random copolymer is stabilizing a perpendicular orientation in the PS-PDMS diblock film.

### Example No. 4

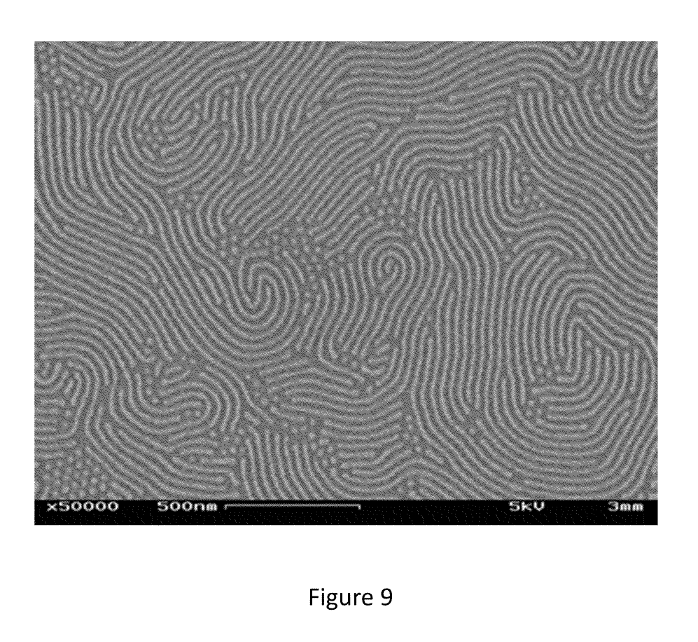

This example was conducted to demonstrate control of the orientation of the PDMS-cylinder forming PS-b-PDMS blend on the random copolymer copoly(methyl methacrylate-ran-trifluoroethyl methacrylate) (Sample #1). The surface modification layer was coated onto silicon substrates by spin coating a solution of the random copolymer at 1.5 wt % in toluene at 3000 rpm. The surface modification layer formed a brush-like surface on the surface of the substrate. The substrates were baked at 250° C. for 20 min, and the excess ungrafted copolymer was then removed by washing with excess toluene. Thin films of a 1:1 wt/wt blend of two different PS-PDMS (PS-PDMS-A, Mn=40 kg/mol, 22 wt % PDMS, and PS-PDMS-B, Mn=25.5 kg/mol, 33 wt % PDMS) were then cast on the coated substrates from propylene glycol methyl ether acetate (PGMEA) solution at a thickness of 43 nm, baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. FIG. 9 is a micrograph showing the thin film block copolymer morphology when disposed on the surface modification layer after annealing at 340° C. for 1 hour. The morphology resembles that of a fingerprint, which is consistent with preferential wetting.

### Example No. 5

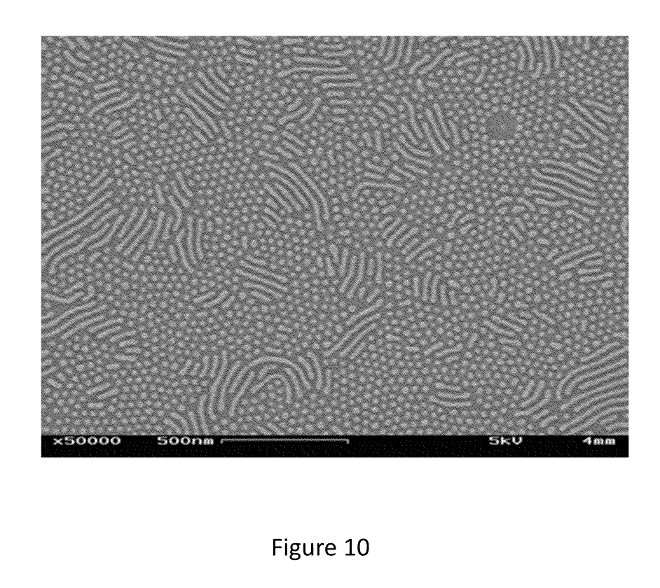

This example was conducted to demonstrate control of the orientation of the PDMS-cylinder forming PS-b-PDMS blend on the random copolymer copoly(methyl methacrylate-ran-trifluoroethyl methacrylate) (Sample #2). The surface modification layer was coated onto silicon substrates by spin coating a solution of the random copolymer at 1.5 wt % in toluene at 3000 rpm. The surface modification layer formed a brush-like surface on the surface of the substrate. The substrates were baked at 250° C. for 20 minutes, and the excess ungrafted copolymer was then removed by washing with excess toluene. Thin films of a 1:1 wt/wt blend of two different PS-PDMS (PS-PDMS-A, Mn=40 kg/mol, 22 wt % PDMS, and PS-PDMS-B, Mn=25.5 kg/mol, 33 wt % PDMS) were then cast on the coated substrates from propylene glycol methyl ether acetate (PGMEA) solution at a thickness of 43 nm, baked at 150° C. for 1 min to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. FIG. 10 is a micrograph showing the thin film morphology on the surface modification layer, which reveals a mixture of parallel and perpendicular cylinders.

### Example No. 6

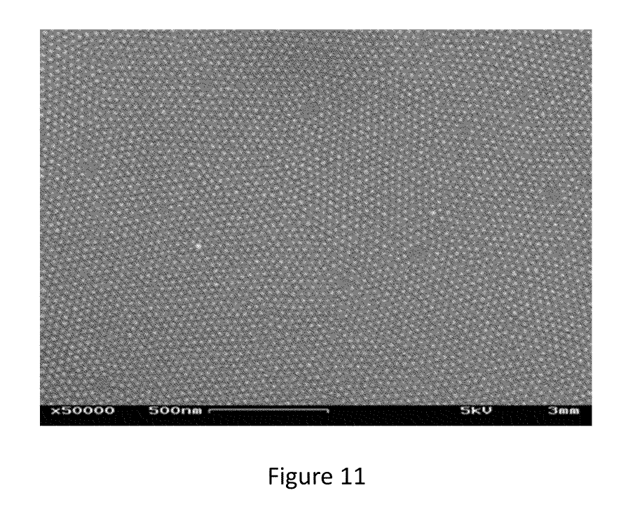

This example was conducted to demonstrate control of the orientation of the PDMS-cylinder forming PS-b-PDMS blend on the random copolymer copoly(methyl methacrylate-ran-dodecafluoroheptylmethacrylate) (Sample #3). The surface modification layer was coated onto silicon substrates by spin coating a solution of the random copolymer at 1.5 wt % in toluene at 3000 rpm. The surface modification layer formed a brush-like surface on the surface of the substrate. The substrates were baked at 250° C. for 20 minutes, and the excess ungrafted random copolymer was then removed by washing with excess trifluorotoluene. Thin films of a 1:1 wt/wt blend of two different PS-PDMS (PS-PDMS-A, Mn=40 kg/mol, 22 wt % PDMS, and PS-PDMS-B, Mn=25.5 kg/mol, 33 wt % PDMS) were then cast on the coated substrates from propylene glycol methyl ether acetate (PGMEA) solution at a thickness of 41 nm, baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. The block copolymer morphology shown in the FIG. 11 on the surface modification layer shows entirely perpendicular cylinders and no sign parallel cylinder morphology. This indicates that the surface modification layer (Sample #3) stabilizes a perpendicular orientation in this film of blended PS-PDMS diblocks.

### Comparative Example No. 3

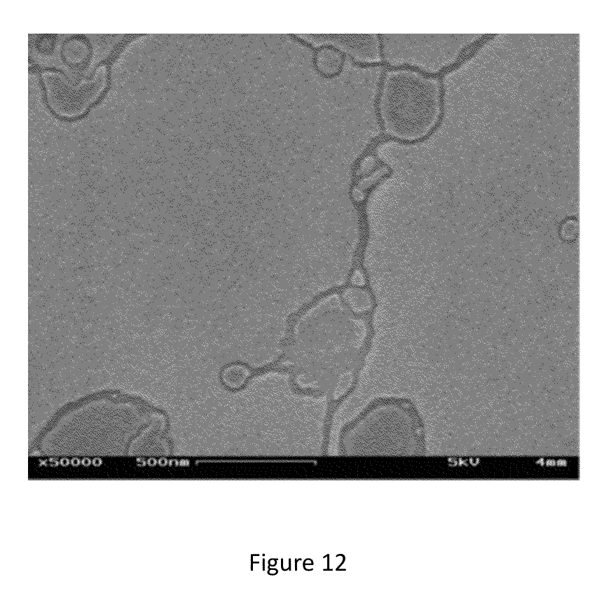

This example was conducted to study the orientation of lamellar PS-b-PDMS on the random copolymer copoly(methyl methacrylate-ran-trifluoroethyl methacrylate) (Sample #1). The surface modification layer was coated onto silicon substrate by spin coating a solution of the random copolymer at 1.5 wt % in toluene at 3000 rpm. The substrate was baked at 250° C. for 20 minutes and the excess ungrafted random copolymer was then removed by washing with excess toluene. A 56 nm thin film of a lamellar morphology PS-PDMS (PS-PDMS-C, Mn=24.2 kg/mol, 45 wt % PDMS) was then cast on the coated substrate from propylene glycol methyl ether acetate (PGMEA) solution at, baked at 150° C. for 1 minute to remove residual PGMEA, and then annealed under nitrogen at 340° C. for 1 hour. After thermal processing, the film was subjected to a short CF₄ reactive ion etch (50 W, 8 seconds) followed by a second etch of oxygen (90 W, 25 seconds) to remove the polystyrene and oxidize the polydimethylsiloxane. The sample was then imaged by scanning electron microscopy to determine domain orientation. FIG. 12 shows the thin film morphology after etching, which shows a morphology consistent with parallel orientation of lamella and no sign of fine structure indicative of perpendicular orientation.

### Example No. 7

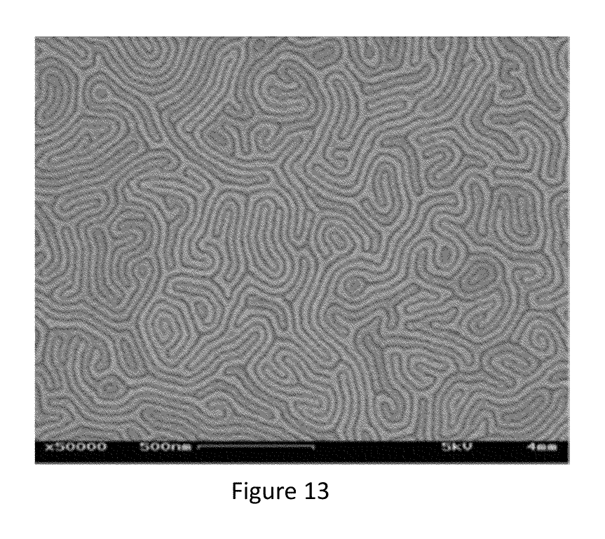

This example was conducted to demonstrate the orientation of lamellar PS-b-PDMS on random copolymer copoly(methyl methacrylate-ran-trifluoroethyl methacrylate) (Sample #2). The surface modification layer was coated onto silicon substrates by spin coating the random copolymer solution at 1.5 wt % in toluene at 3000 rpm. The substrates were baked at 250° C. for 20 minutes and the excess ungrafted random copolymer was then removed by washing with excess toluene. Thin films of a lamellar morphology PS-PDMS (PS-PDMS-C, Mn=24.2 kg/mol, 45 wt % PDMS) were then cast on the coated substrates from propylene glycol methyl ether acetate (PGMEA) solution at the desired thickness, baked at 150° C. for 1 minute to remove residual PGMEA, and the samples were then annealed under nitrogen at various temperatures and times. After thermal processing, the films were subjected to a short CF₄ reactive ion etch (50 W, 8 seconds) followed by a second etch of oxygen (90 W, 25 seconds) to remove the polystyrene and oxidize the PDMS. The samples were then imaged by scanning electron microscopy to determine domain orientation. FIG. 13 is a photomicrograph showing the thin film morphology after etching as a function of film thickness and annealing temperature, which reveals that perpendicular orientations of PS-b-PDMS diblocks can be stabilized by proper selection of random copolymer, film thickness, and annealing conditions. FIG. 13 is a micrograph of 43 nm films annealed at 290° C. for 1 hour. This image reveals a fingerprint morphology consistent with stable perpendicular lamellar morphologies.

### Example No. 8

This example was conducted to demonstrate the orientation of lamellar PS-b-PDMS on random copolymer copoly(methyl methacrylate-ran-trifluoroethyl methacrylate) (Sample #2). The surface modification layer was coated onto a silicon substrate by spin coating the random copolymer solution at 1.5 wt % in toluene at 3000 rpm. The substrate was baked at 250° C. for 20 minutes and the excess ungrafted random copolymer was then removed by washing with excess toluene. A thin film of a lamellar morphology PS-PDMS (PS-PDMS-C, Mn=24.2 kg/mol, 45 wt % PDMS) was then cast on the coated substrates from propylene glycol methyl ether acetate (PGMEA) solution at 41.8 nm thickness, baked at 150° C. for 1 minute to remove residual PGMEA, and the sample was then annealed under nitrogen at 340° C. for one hour.

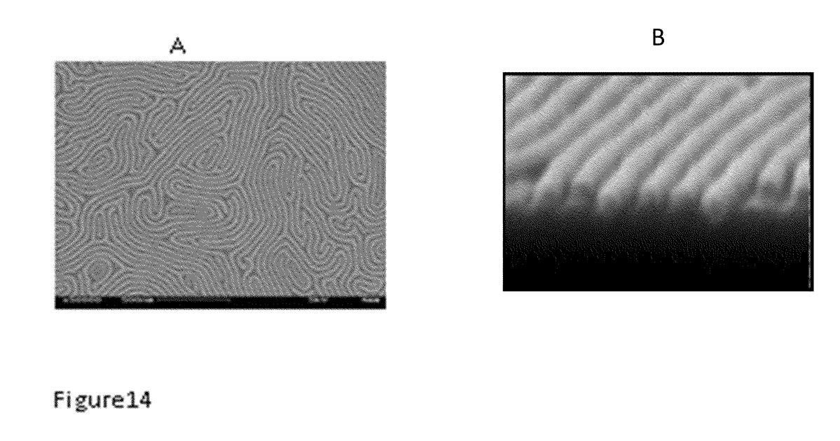

After thermal processing, the film was subjected to a short CF₄ reactive ion etch (50 W, 8 seconds) followed by a second etch of oxygen (90 W, 25 s) to remove the polystyrene and oxidize the PDMS. The sample was then imaged by scanning electron microscopy to determine domain orientation. FIG. 14A is a photomicrograph showing the thin film morphology after etching, which reveals a fingerprint morphology consistent with a stable perpendicular lamellar morphology. This substrate was also cleaved in order to view the cross section of the morphology, which revealed oxidized PDMS lines with a height of ˜25 nm (FIG. 14B). This indicates that the random copolymer (Sample #2) is stabilizing a perpendicular cylindrical morphology in this PS-PDMS diblock film. These oxidized PDMS lines are useful as etch masks for pattern transfer to create line patterns.

These examples demonstrate that the random copolymers can be used to create block copolymeric films having interdomain spacings of less than 20 nanometers, specifically 7 to 8 nanometers. By controlling the composition of the random copolymer and the block copolymer, the domain sizes, orientation and the interdomain spacings can be tuned to obtain useful films that can be used as templates in the production of semiconductors, random access memory, and the like.

What is claimed is:

1. A polymer composition, comprising a random copolymer derived by reacting:
a monomer represented by formula (1): 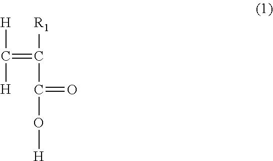
where R₁ is a hydrogen or an alkyl group having 1 to 10 carbon atoms; or a monomer having a structure represented by the formula (2): 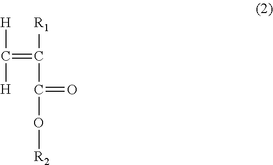
where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group; with a monomer that has at least one fluorine atom substituent and that has a structure represented by the formula (3): 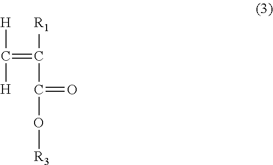
where R₁ is a hydrogen or an alkyl group having 1 to 10 carbon atoms and R₃ is a C₂₋₁₀ fluoroalkyl group.

2. The random copolymer of claim 1, where the copolymer has the structure of formula (4): 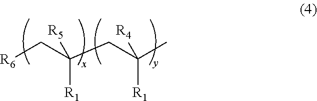
wherein x and y are mole fractions whose sum is equal to 1, where x is 0.001 to 0.999, and y is 0.001 to 0.999; where R₁ is a hydrogen or a C₁₋₁₀ alkyl group and is the same or different in different repeat units, R₄ is a carboxylic acid group, a C₁₋₁₀ alkyl ester group, a C₃₋₁₀ cycloalkyl ester group or a C₇₋₁₀ aralkyl ester group and R₅ is a C₂₋₁₀ fluoroalkyl ester group; and wherein R₆ represents an end group that comprises a hydroxyl group, carboxylic acid group, epoxy group, silane group, or a combination comprising at least one of the foregoing groups.

3. The random copolymer of claim 1, where the copolymer has the structure of formula (7): 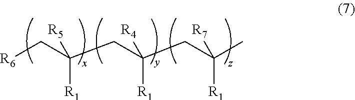
where x, y and z are mole fractions, the sum of which are equal to 1, where x is 0.001 to 0.999, where y is 0.001 to 0.999; R₁ is a hydrogen or a C₁₋₁₀ alkyl group and is the same or different in each of the repeat units; R₄ is a carboxylic acid group, a C₁₋₁₀ alkyl ester group, a C₃₋₁₀ cycloalkyl ester group or a C₇₋₁₀ aralkyl ester group; R₅ is a C₂₋₁₀ fluoroalkyl ester group; R₇ is either a C₂₋₁₀ fluoroalkyl ester group that is not the same as R₅ or is a C₁₋₁₀ alkyl ester group, a C₃₋₁₀ cycloalkyl ester group or a C₇₋₁₀ aralkyl ester group that is not the same as R₄; and wherein R₆ represents an end group that comprises a hydroxyl group, carboxylic acid group, epoxy group, silane group, or a combination comprising at least one of the foregoing groups.

4. The random copolymer of claim 1, having a number averaged molecular weight of 10,000 to 20,000 g/mol, and a polydispersity index of less than or equal to 1.3.

5. The random copolymer of claim 1, comprising 0.1 to 40 mol % of (meth)acrylate monomer having the C₂₋₁₀ fluoroalkyl ester group.

6. The random copolymer of claim 1, comprising copoly(methyl methacrylate-ran-trifluoro ethyl methacrylate).

7. The random copolymer of claim 1, comprising copoly(methyl methacrylate-ran-dodecafluoroheptylmethacrylate).

8. A method of forming a pattern, comprising:
disposing a block copolymer comprising a siloxane-containing block and a non-siloxane containing block, on a surface of a substrate having a random copolymer disposed thereon; the random copolymer having a total surface energy of 15 to 40 milliNewtons per meter and comprising at least one substituent that comprises a fluorine atom;
annealing the block copolymer to phase separate regions containing the siloxane containing block from those containing the non-siloxane containing block, and
etching the block copolymer to selectively remove either the region containing the siloxane-containing block, or the non-siloxane containing block.

9. The method of claim 8, wherein the random copolymer forms a patterned brush layer on the surface of the substrate.

10. The method of claim 8, wherein the random copolymer forms a mat layer on the surface of the substrate.

11. The method of claim 8, where the annealing is the result of a thermal process.

12. The method of claim 8, where the random copolymer is derived by reacting a monomer having a structure represented by formula (1): 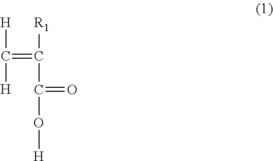
where R₁ is a hydrogen or an alkyl group having 1 to 10 carbon atoms; or a monomer having a structure represented by the formula (2): 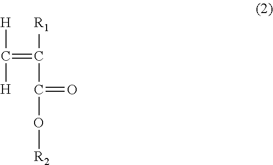
where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group; with a monomer that has at least one fluorine atom substituent and that has a structure represented by the formula (3): 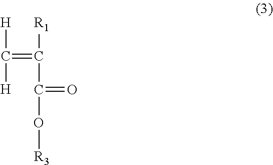
where R₁ is a hydrogen or an alkyl group having 1 to 10 carbon atoms and R₃ is a C₂₋₁₀ fluoroalkyl group; where the random copolymer has an attachment group or a chain terminating group that comprises a hydroxyl group, carboxylic acid group, epoxy group, silane group, or a combination comprising at least one of the foregoing groups.

14. The method of claim 9, wherein the brush layer is bonded to the surface by coating the brush layer on the surface, heating to form a covalent bond to the surface through a chain terminating group, the attachment group, or both the chain terminating group and the attachment group, and washing the surface with a solvent to remove unbonded random copolymer.

15. The method of claim 8, wherein a non-etched region comprises a lamellar or a cylinder that has a longitudinal axis that is perpendicular to a perpendicular drawn to the surface of the substrate or is parallel to a perpendicular drawn to the surface of the substrate.

16. A patterned substrate, comprising:
a substrate having a random copolymer disposed thereon; the random copolymer derived by reacting a monomer represented by formula (1): 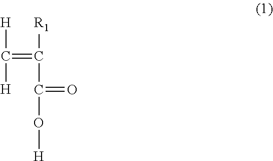
where R₁ is a hydrogen or an alkyl group having 1 to 10 carbon atoms; or a monomer having a structure represented by the formula (2): 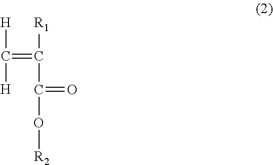
where R₁ is a hydrogen or an alkyl group having 1 to 10 carbon atoms and R₂ is a C₁₋₁₀ alkyl, a C₃₋₁₀ cycloalkyl, or a C₇₋₁₀ aralkyl group; with a monomer that has at least one fluorine atom substituent and that has a structure represented by the formula (3): 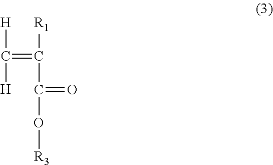
where R₁ is a hydrogen or an alkyl group having 1 to 10 carbon atoms and R₃ is a C₂₋₁₀ fluoroalkyl group; where the random copolymer comprises an attachment group or a chain terminating group that comprises a hydroxyl group, carboxylic acid group, epoxy group, silane group, or a combination comprising at least one of the foregoing groups; and
a pattern layer disposed on the random copolymer, the pattern layer comprising a block copolymer comprising a siloxane-containing block and a non-siloxane containing block phase separated into regions containing the siloxane containing block and the non-siloxane containing block, wherein the phase separated regions are lamellar having a longitudinal axis oriented parallel to the surface, or cylindrical having a longitudinal axis oriented perpendicular to the surface, or both.

17. The patterned substrate of claim 16, wherein the random copolymer forms a patterned brush layer on the surface of the substrate.

18. The patterned substrate of claim 16, wherein the random copolymer forms a mat layer on the surface of the substrate.
